(19) United States
(12) Patent Application Publication
(10) Pub. No.: US 2015/0036942 A1
(43) Pub. Date: Feb. 5, 2015

(54) OBJECT RECOGNITION AND TRACKING USING A CLASSIFIER COMPRISING CASCADED STAGES OF MULTIPLE DECISION TREES

(71) Applicant: LSI Corporation, San Jose, CA (US)

(72) Inventors: Maxim Smirnov, Wilsonville, OR (US); Michael A. Pusateri, Port Matilda, PA (US)

(73) Assignee: LSI Corporation, San Jose, CA (US)

(21) Appl. No.: 14/212,312

(22) Filed: Mar. 14, 2014

Related U.S. Application Data
(60) Provisional application No. 61/908,260, filed on Nov. 25, 2013.
(60) Provisional application No. 61/860,735, filed on Jul. 31, 2013.

(51) Int. Cl. G06K 9/62

(52) U.S. Cl. CPC G06K 9/6282
USPC 382/227

(57) ABSTRACT

An image processor comprises first and second hardware accelerators and is configured to implement a classifier. The classifier in some embodiments comprises a cascaded classifier having a plurality of stages with each such stage implementing a plurality of decision trees. At least one of the first and second hardware accelerators of the image processor is configured to generate an integral image based on a given input image, and the second hardware accelerator is configured to process image patches of the integral image through one or more of a plurality of decision trees of the classifier implemented by the image processor. By way of example, the first and second hardware accelerators illustratively comprise respective front-end and back-end accelerators of the image processor, and an integral image calculator configured to generate the integral image based on the given input image is implemented in one of the front-end accelerator and the back-end accelerator.

### FIELD OF INVENTION

The field relates generally to image processing, and more particularly to image processing for performing functions such as object recognition and tracking.

### BACKGROUND

Image processing is important in a wide variety of different applications, and such processing may involve two-dimensional (2D) images, three-dimensional (3D) images, or combinations of multiple images of different types. For example, some applications utilize a 3D image generated using a depth imager such as a structured light (SL) camera or a time of flight (ToF) camera. These and other 3D images, which are also referred to as depth images, are commonly utilized in computer vision applications that involve recognition and tracking of gestures, faces or other types of objects. Such computer vision applications include, for example, video gaming systems or other types of image processing systems that implement a human-machine interface.

### SUMMARY

In one embodiment, an image processor comprises first and second hardware accelerators and is configured to implement a classifier. The classifier may comprise, for example, a cascaded classifier having a plurality of stages with each such stage implementing a plurality of decision trees. At least one of the first and second hardware accelerators of the image processor is configured to generate an integral image based on a given input image, and the second hardware accelerator is configured to process image patches of the integral image through one or more of a plurality of decision trees of the classifier implemented by the image processor.

By way of example, the first and second hardware accelerators illustratively comprise respective front-end and back-end accelerators of the image processor, and an integral image calculator configured to generate the integral image based on the given input image is implemented in one of the front-end accelerator and the back-end accelerator.

### BRIEF DESCRIPTION OF THE FIGURES

FIG. 1 shows an example of a cascaded classifier in an illustrative embodiment.

FIG. 2 shows multiple decision trees in a given stage of the cascaded classifier of FIG. 1.

FIGS. 3(A) and 3(B) illustrate exemplary integral image types.

FIG. 4 illustrates a rectangular sum calculation based on an integral image.

FIG. 5 is a block diagram of an image processor that implements a cascaded classifier in an illustrative embodiment.

FIG. 6 is a block diagram showing one possible embodiment of a front-end accelerator of the image processor of FIG. 5.

FIG. 7 is a block diagram showing one possible embodiment of a back-end accelerator of the image processor of FIG. 5.

FIG. 8 illustrates an exemplary multithreading process implemented in the back-end accelerator of FIG. 7.

FIG. 9 illustrates an exemplary dataflow in the image processor of FIG. 5.

FIGS. 10 and 11 are block diagrams showing respective other embodiments of an image processor that implements a cascaded classifier.

FIG. 12 illustrates buffering of integral images in the embodiments of FIGS. 10 and 11.

FIG. 13 illustrates bi-linear interpolation of integral images and squared integral images in the embodiments of FIGS. 10 and 11.

FIG. 14 illustrates directional bi-linear interpolation of tilted integral images in the embodiments of FIGS. 10 and 11.

### WRITTEN DESCRIPTION

Embodiments of the invention will be illustrated herein in conjunction with exemplary image processing systems that include image processors or other types of processing devices and implement techniques for recognition and tracking of objects in images. It should be understood, however, that embodiments of the invention are more generally applicable to any image processing system or associated device or technique that involves detection of at least one object in one or more images. The term “object” as used herein is intended to be broadly construed so as to encompass, for example, animate or inanimate objects, or combinations or portions thereof, including portions of a human body such as a hand or face.

Embodiments of the invention include but are not limited to methods, apparatus, systems, processing devices, integrated circuits, and computer-readable storage media having computer program code embodied therein.

For example, methods and apparatus for object recognition and tracking in embodiments of the invention can be used in a wide variety of general purpose computer vision or machine vision applications, including but not limited to gesture recognition or face recognition modules of human-machine interfaces.

Some embodiments of the invention are configured to utilize classification techniques that are based at least in part on a Viola-Jones classifier. Such classifiers can be trained to recognize a wide variety of user-specified patterns, possibly through the use of an AdaBoost machine learning framework.

Details regarding conventional aspects of cascaded classification can be found in, for example, P. Viola and M. Jones, “Rapid object detection using a boosted cascade of simple features,” Proceedings of the 2001 IEEE Computer Society Conference on Computer Vision and Pattern Recognition (CVPR), Vol. 1, pp. 1-511 to 1-518, 2001; R. Lienhart and J. Maydt, “An extended set of Haar-like features for rapid object detection,” Proceedings of the 2002 International Conference on Image Processing, Vol. 1, pp. 1-900 to 1-903, 2002; and Y. Freund and R. E. Schapire, “A decision-theoretic generalization of on-line learning and an application to boosting,” Journal of Computer and System Sciences, Vol. 55, Issue 1, pp. 119-139, August 1997, all of which are incorporated by reference herein.

It is to be appreciated, however, that embodiments of the invention are not limited to use with Viola-Jones type classifiers. Accordingly, other types of classifiers may be adapted for use in other embodiments.

FIG. 1 shows one example of a cascaded classifier 100 that is implemented in an image processor in an illustrative embodiment. The cascaded classifier 100 in this example is configured as a detector and includes a cascade of N+1 stages 102-0, 102-1, . . . 102-N, also denoted Stage 0 through Stage N, respectively. An image patch (e.g., a monochrome image patch sampled at a certain resolution scale) is applied as an input to the initial stage. The image patch may be implemented, for example, using a predefined template, although other types of image patches can be used. The image patch passes through the classifier 100 one stage at a time. Each stage 102 computes a patch score and compares the computed patch score to a predetermined stage threshold. If the score exceeds the threshold within a current stage, the image patch is passed on to the next stage, unless the current stage is the final stage, where the score exceeding the threshold results in a detection event. Otherwise, the image patch is rejected at the current stage and the detection process ends.

In the present embodiment, the image patch is assumed to be generated using a template having a predetermined fixed size, such as, for example, 20×32 or 24×36 pixels, although other template sizes can additionally or alternatively be used.

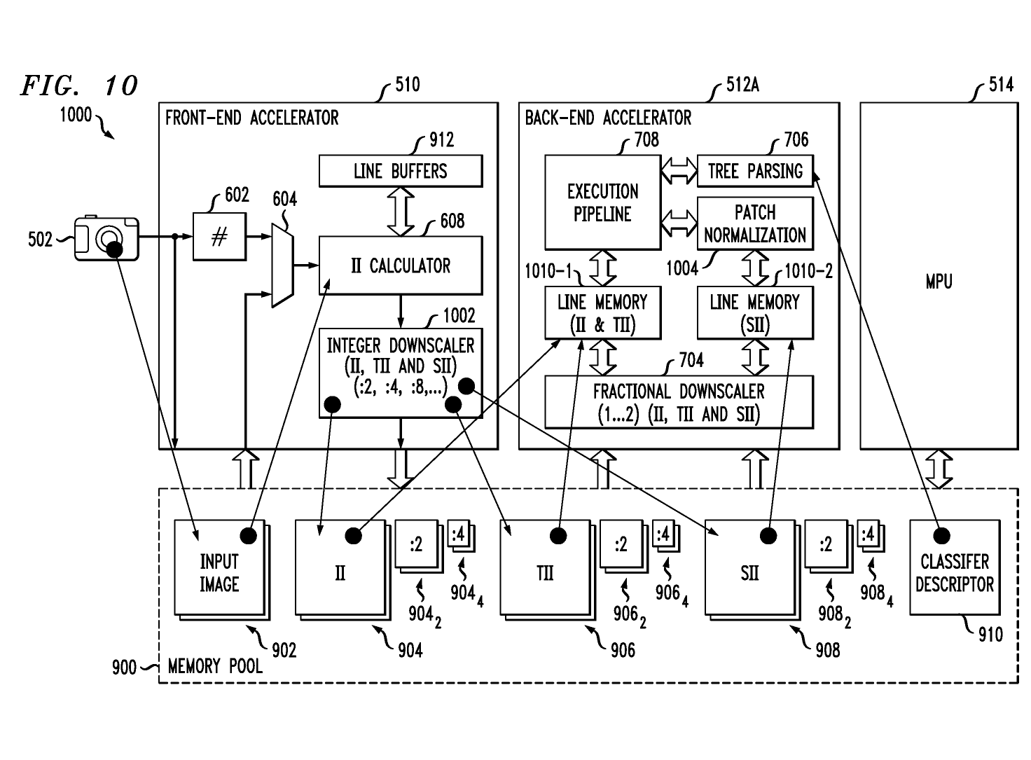

Other embodiments need not utilize an image patch or template having any particular predetermined fixed size, but instead generate multiple downscaled versions of a given image or image patch. Examples of embodiments of this type will be described below in conjunction with FIGS. 10-14.

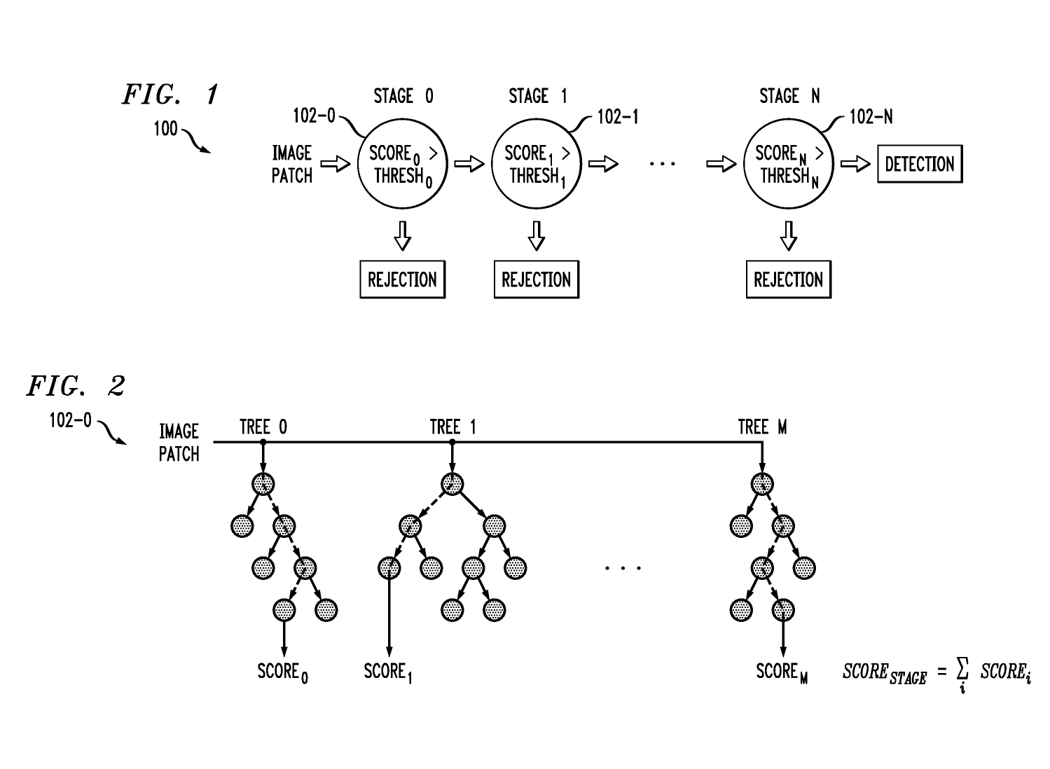

Each stage 102 in the FIG. 1 embodiment comprises several concatenated entropy trees, also referred to as decision trees, through which the image patch is processed to generate the score for that stage, as illustrated in FIG. 2. The particular stage 102-0 shown in this figure includes M+1 decision trees denoted Tree 0 through Tree M. A dashed line shows an exemplary path through each tree in generating a particular score. Each of the other stages 102-1 through 102-N is also assumed to comprise multiple decision trees similar to those shown in FIG. 2 for stage 102-0, although the particular number, type and arrangement of decision trees used can vary from stage to stage within the classifier 100.

In some embodiments, each stage 102 may have an average of about 12 trees, but there need not be any specified minimum or maximum number of trees in any given stage. The full cascaded classifier 100 typically contains on the order of 400 trees, but this number can be larger for more elaborate classifiers. Also, other embodiments may use a cascaded classifier with significantly fewer than 400 trees. Each tree may be configured to have up to designated maximum numbers of non-leaf and leaf nodes, such as up to seven non-leaf nodes and up to eight leaf nodes, although other implementations may impose no such restrictions on the total numbers of nodes in a given tree.

The result of a node operation in a given one of the decision trees of FIG. 2 is to move to one of two subsequent nodes. These subsequent nodes are either a child node or a leaf node. Leaf nodes are terminal and do not involve further tree calculation. The tree structure is not required to be symmetric, or otherwise full or perfect. A given image patch is passed through the trees independently, and receives a score for every tree. The total score of a stage is given by the sum of all the individual tree scores.

Each tree node in the present embodiment is assumed to have a Haar-like feature associated with it. A Haar-like feature may comprise a weighted sum of image sums calculated over respective rectangles lying in a fixed position and orientation in the image patch, as will be described in more detail below. The complete tree descriptor can be stored in a memory of an image processor as a linked list of tree nodes, with each such node containing the addresses or other indices of its attached left and right nodes. An exemplary node descriptor in the present embodiment illustratively includes the following fields:
Haar-like feature descriptor:
   Rectangle #1:
      Vertical origin
      Horizontal origin
      Width
      Height
      Weight
   Rectangle #2:
      . . .
      . . .
   Rectangle #K:
      . . .
   “Is tilted” (e.g., “0”—no rotation, “1” —the feature is rotated by 45 degrees clockwise)
Node threshold
Next left node index (NULL for leaf nodes)
Next right node index (NULL for leaf nodes)
Left leaf value (if a left leaf node)
Right leaf value (if a right leaf node)

The process of traversing a given one of the trees illustrated in FIG. 2 can be implemented as follows:

1. Start from the root node of the tree.

2. Using an integral image, sum the values of the corresponding image patch under each of the K rectangles of the Haar-like feature. Weight each sum by the rectangle's weight, and sum all those values.

3. Compare the resulting weighted sum to the node threshold. If the weighted sum is smaller than the threshold, then proceed to the next left node; otherwise go to the next right node.

4. Repeat from (2), until a leaf node is reached. If the current node is a left or right leaf, go to (5).

5. Return the resulting leaf value as the score for that tree.

The use of integral images simplifies calculation of Haar-like features associated with respective tree nodes in illustrative embodiments. Some embodiments utilize one or more of three different types of integral images, namely, integral image (II), squared integral image (SII), and tilted integral image (TII). These exemplary integral images may be calculated, for example, using the luminosity (Y) component of the input image, although other input image components may be used in other embodiments. Also, other types and arrangements of integral images may be used, and the term “integral image” as used herein is therefore intended to be broadly construed. Integral images are illustratively generated from an input image, and the term “input image” is also intended to be broadly construed as encompassing any set of pixels that may be input to a process for generating an integral image. A given integral image in some embodiments is assumed to comprise multiple image patches, but in other embodiments may comprise a single image patch, where the term “patch” generally refers to a portion of an image.

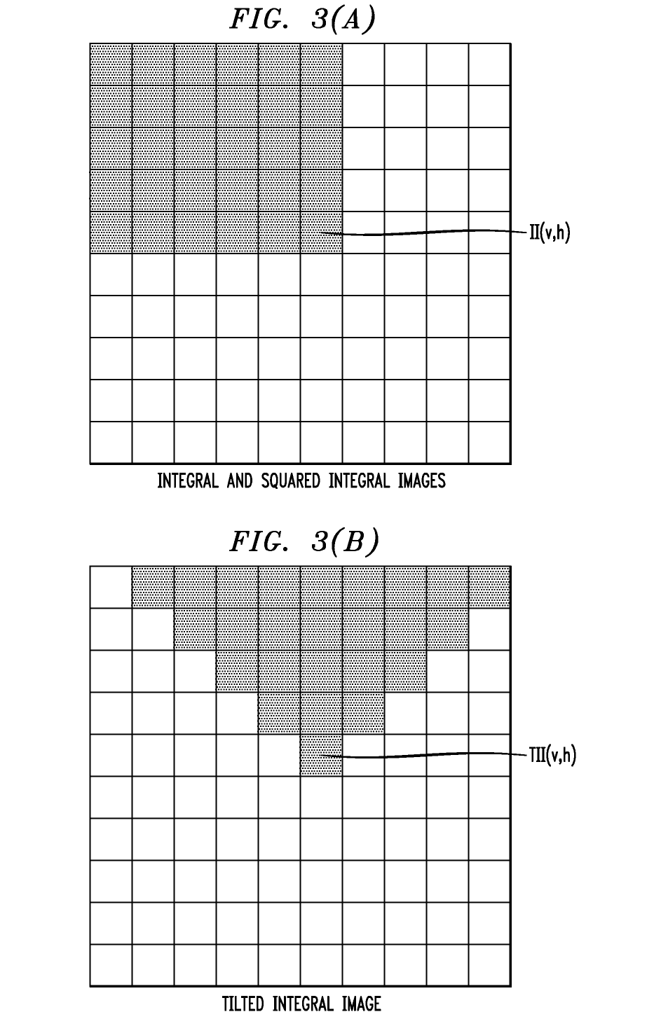

FIG. 3(A) illustrates calculation of integral and squared integral images. In this embodiment, II and SII samples at a given location (v, h) are calculated as a sum of the input image pixels (marked with darker shading in the figure) in accordance with the following equations:

$$II ( v , h ) = {\sum }_{{v}_{i} \leq v} {\sum }_{{h}_{i} \leq h} I ( {v}_{i} , {h}_{i} )$$

$$SII ( v , h ) = {\sum }_{{v}_{i} \leq v} {\sum }_{{h}_{i} \leq h} {I}^{2} ( {v}_{i} , {h}_{i} )$$

In the foregoing equations, I(vᵢ, hᵢ) and I² (vᵢ, hᵢ) denote respective pixel values and squared pixel values for a given pixel location (vᵢ, hᵢ), where vᵢ and hᵢ denote respective row and column numbers in the case of a rectangular image.

FIG. 3(B) illustrates calculation of a tilted integral image. As in the previous case, the sum is calculated over pixels marked with darker shading. The TII calculation process can be performed in accordance with the recursive equation below:

TII(v,h)=I(v,h)+I(v−1,h)+TII(v−1,h−1)+TII(v−1,h+1)−TII(v−2,h)

where pixels with indexes outside the image boundary are treated as having a value of zero.

By way of example, a Haar-like feature HF may be in the form of a weighted sum of double sums R over the input image, in accordance with the following equation:

$$H F = {\sum }_{i} {w}_{i} {R}_{i}$$

where a given double sum R may be computed as follows:

$$R ( {v}_{0} , {h}_{0} , {v}_{1} , {h}_{1} ) = {\sum }_{{v}_{0} < v {\leq }_{1}} {\sum }_{{h}_{0} < h \leq {h}_{1}} I ( v , h )$$

The double sum R is also referred to herein as a “rectangle sum.” In the case of an integral image, the above equation for the rectangular sum can be simplified as follows:

R(v₀,h₀,v₁,h₁)=II(v₁,h₁)+II(v₀,h₀)−II(v₁,h₀)−II(v₀,h₁).

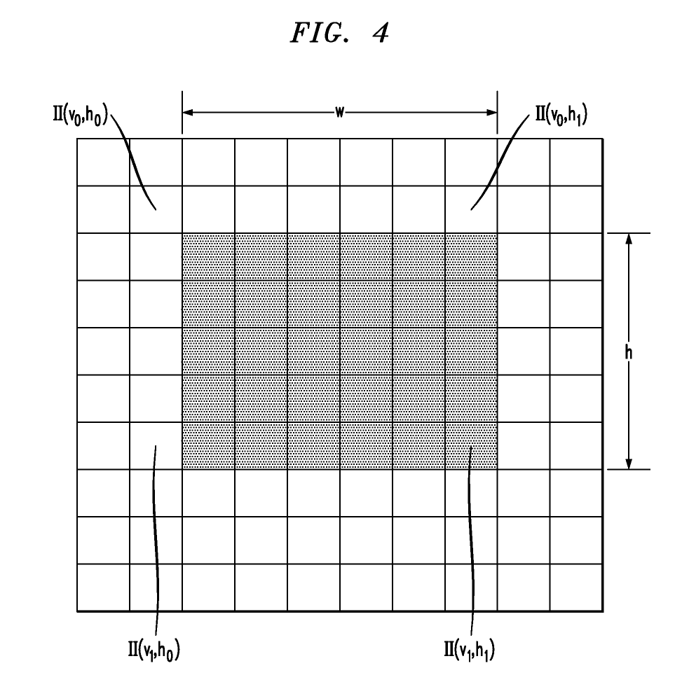

The rectangle sum calculation for an integral image is illustrated in FIG. 4. The calculation is performed over a rectangle of height h and width w in pixels.

A similar calculation approach can be used with squared and tilted integral images. Note that a single integral image (e.g., pre-calculated once at the finest resolution) may be further used to compute Haar-like features at all coarser resolution scales.

In some embodiments, a classifier such as classifier 100 based on a cascade of multiple stages 102 each comprising multiple decision trees is implemented in an image processor comprising a System-on-a-Chip (SoC). The SoC includes a microprocessor unit (MPU) and a set of hardware accelerators, and employs hardware-software partitioning. Other embodiments may include additional or alternative components for capturing images from an imaging sensor, calculating integral images and Haar-like image features and traversing decision trees.

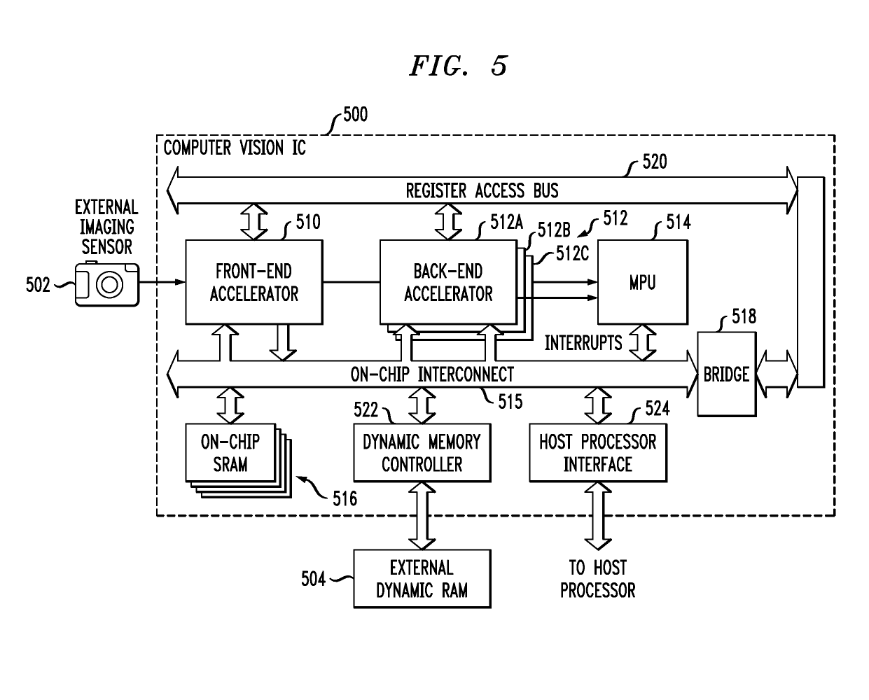

FIG. 5 shows an illustrative embodiment of the above-noted SoC, in this case implemented as a computer vision integrated circuit (IC) 500 for use in an image processing system. The IC 500 is adapted for coupling to an external imaging sensor 502, illustratively a camera or other type of imager, and to an external dynamic random access memory (DRAM) 504. The imaging sensor 502 and external DRAM 504 comprise exemplary components of an image processing system that incorporates the IC 500, although additional or alternative components could be used in other embodiments.

The IC 500 in this embodiment comprises a front-end accelerator 510 adapted for coupling to the external imaging sensor 502, a back-end accelerator 512, an MPU 514, on-chip interconnects 515, and an internal or on-chip static random access memory (SRAM) 516. The on-chip interconnects 515 are coupled via a bridge 518 to a register access bus 520.

The internal SRAM 516 in combination with the external DRAM 504 provide a memory pool for the IC 500. This memory pool comprising a combination of internal and external memory is also referred to herein as a “main memory” of the IC 500. The external DRAM 504 in this embodiment is used as MPU program and data memory, frame buffers for images and integral images, and tree descriptor storage. The IC 500 accesses the external DRAM 504 via a dynamic memory controller 522. It should be noted that other arrangements of additional or alternative memories and associated controllers or other components can be used in other embodiments of an SoC IC or other type of image processor herein.

The back-end accelerator 512 of IC 500 illustratively includes multiple back-end accelerator instances 512A, 512B and 512C that operate in parallel with one another in order to enhance overall system performance. The internal SRAM 516 also illustratively includes multiple SRAM instances as shown. A given such SRAM instance may be associated with a corresponding one of the back-end accelerator instances 512.

The IC 500 in the FIG. 5 embodiment implements an exemplary hardware-software partitioning approach. In accordance with this particular embodiment of hardware-software partitioning, well-structured and time consuming tasks are assigned to the hardware while irregularly-structured tasks that involve branching, but do not require extensive computations, are executed in the software on a general purpose processor. The partitioning also ensures that the hardware-software interface is as simple as possible and interactions between the hardware and the software are not intensive.

The front-end accelerator 510, which may be viewed as comprising or being implemented as a preprocessor component of the SoC image processor, performs image signal processing operations, conversion of color images to monochrome representation, calculation of integral images, and frame buffer management. Such operations may be performed in an on-the-fly manner, or using other techniques.

Examples of image signal processing operations performed by the front-end accelerator 510 include bad pixel correction, black level adjustment, sensor quantum efficiency (QE) compensation, white balance, Bayer pattern interpolation, color correction, auto-exposure, auto-white balance and auto-focus statistic gathering, tone mapping, lens shading correction, lens geometric distortion correction, chromatic aberration correction, saturation adjustment, and image cropping and resizing. The operations are examples of what are also referred to herein as ISP operations, where ISP denotes “image signal processing.”

The back-end accelerator 512 is designed to exercise fast processing at a tree level. It performs Haar-like feature calculation, decision tree parsing and tree score calculation.

The remaining operations are performed on the MPU 514. These operations include region-of-interest (ROI) detection, calculations at stage and cascade detector and pose levels, interrupt processing, accelerator control, search, tracking, gesture detection, buffer management, host processor communication, and minor calculations.

The IC 500 as shown in FIG. 5 further includes a host processor interface 524 that allows the IC 500 to interface with an external host processor, not explicitly shown in the figure, which may comprise a general purpose processor of a higher-level processing device that incorporates the IC.

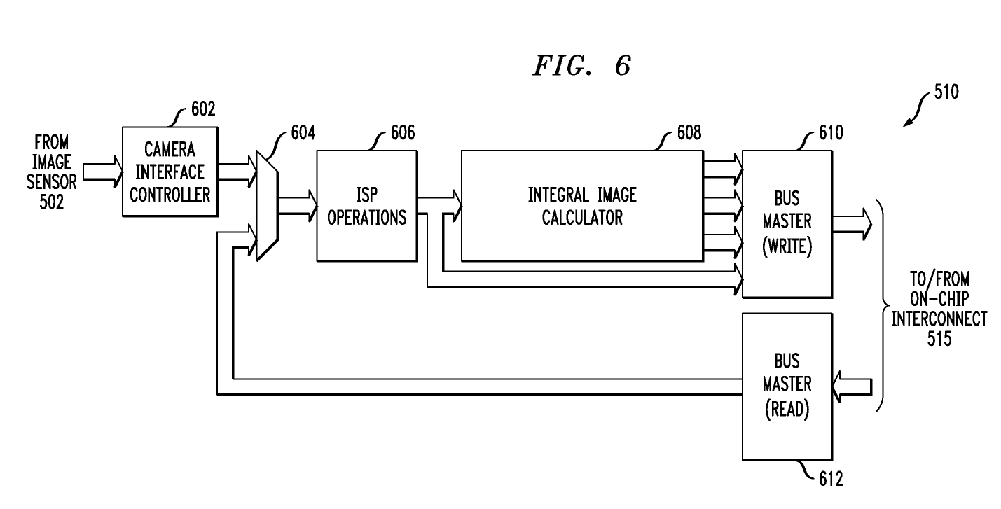

A more detailed view of an embodiment of the front-end accelerator 510 is shown in FIG. 6. The front-end accelerator 510 in this embodiment is coupled to the external imaging sensor 502 via a camera interface controller 602 and a first input of a multiplexer 604. The front-end accelerator 510 further comprises an ISP operations unit 606, an integral image calculator 608 and respective write and read bus masters 610 and 612, also denoted as Bus Master (Write) and Bus Master (Read), respectively. The write bus master 610 has inputs coupled to respective outputs of the ISP operations unit 606 and the integral image calculator 608, and has an output coupled to the on-chip interconnects 515. The read bus master 612 has an input coupled to the on-chip interconnects 515 and an output coupled to a second input of the multiplexer 604. The output of the multiplexer 604 drives an input of the ISP operations unit 606.

In the present embodiment, the front-end accelerator 510 illustratively receives uncompressed image data in a raster scan order from either the external imaging sensor 502 or the main memory, based on configuration of the multiplexer 604, performs image signal processing operations in ISP operations unit 606, if required, and crops and down-scales the image to the desired size and calculates the integral images in integral image calculator 608.

The cropped and downscaled image and the integral images are sent to the main memory for storage via the bus master 610. Once the frame processing has been complete, the front-end accelerator 510 raises an interrupt signal indicating that its output data is ready for further processing.

The front-end accelerator 510 as illustrated in FIG. 6 is assumed to utilize multiple memory buffers. For example, in one possible implementation, the front-end accelerator may be configured to utilize up to four memory buffers for image storage, automatically incrementing a buffer identifier or ID (e.g., a buffer reference number) for every new frame. This facilitates implementation of double, triple and quadruple frame buffering schemes.

Buffer management techniques are applied to ensure image frame data integrity. This may be particularly desirable when working with a real time source in situations in which timely processing of the front-end accelerator output data cannot be guaranteed. By way of example, each buffer can be assigned a “free” or “in-use” flag, with all the buffers initially designated as “free.” After the front-end accelerator completely fills a given buffer it marks it as “in-use” and the buffer keeps its “in-use” status until explicitly released by the software. When a new image frame arrives, the front-end accelerator finds the next available “free” buffer and stores data in it. In case all the buffers are marked “in-use” and a new frame arrives, the front-end accelerator, depending upon the selected policy, either drops the frame or overwrites the last used buffer with the new frame data.

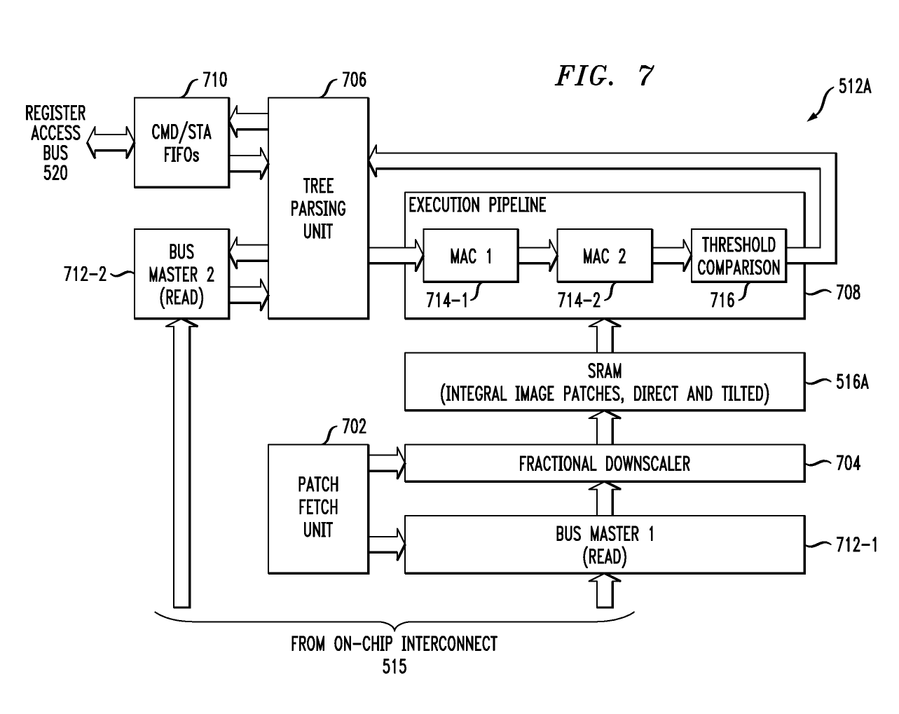

Referring again to FIG. 5, the back-end accelerator 512 is configured to fetch image patches with a given offset and scale, calculate decision tree scores and report them back to the MPU 514 thus accelerating the cascaded classifier calculations. An exemplary instance 512A of the multiple parallel instances of the back-end accelerator 512 will be described in more detail below in conjunction with FIG. 7.

Although the back-end accelerator 512 in the present embodiment targets cascaded classifier structures, it can be adapted in a straightforward manner to other tree-based classifiers, such as a random forest classifier, since the back-end accelerator in this embodiment treats each tree as an independent entity and the overall classifier structure is defined by the software executed on the MPU 514. The software also has freedom of tree score interpretation and can treat the score as a class number when, for example, implementing majority voting classification in a random forest classifier.

As illustrated in FIG. 7, the back-end accelerator 512A in this embodiment comprises a patch fetch unit 702, a fractional downscaler 704, a tree parsing unit 706, an execution pipeline 708, a set of command and status (CMD/STA) FIFOs 710 coupled to the register access bus 520, and read bus masters 712-1 and 712-2, also denoted in the figure as Bus Master 1 and Bus Master 2, respectively, coupled to on-chip interconnects 515. The read bus masters 712 may be implemented, for example, as respective AXI read master controllers. An instance 516A of the on-chip SRAM 516 implements image patch buffers for storing integral image patches, both direct and tilted.

The patch fetch unit 702 reads patches of the integral and tilted integral images (e.g., up to 64×64 pixels in size in one possible implementation) from the main memory via read bus master 712-1 and stores them in the local SRAM 516A, which is assumed to comprise a dual-port SRAM. The size of the SRAM 516A is illustratively configured to allow storage of two integral and tilted integral image patches so that memory access can be organized in a ping-pong fashion in which one pair of patches is being processed while the other pair is being read. The patch fetch unit is also referred to herein as a “data fetch unit.”

The fetch process is initiated by the MPU 514 by writing a fetch command into a patch fetch unit command register, not explicitly shown in the figure. After the fetch process has been completed, a corresponding interrupt is asserted.

The tree parsing unit 706 reads decision tree nodes from the main memory via read bus master 712-2 and schedules feature calculation and threshold comparison in the execution pipeline 708. Once one node is processed, the left or right child node is identified to be processed next. Then the tree parsing unit 706 fetches the descriptor of next node and calculations continue until a leaf node is reached.

The calculation process is initiated by the MPU 514 by writing a tree root pointer into a command FIFO in the set of FIFOs 710. Once the last node of the tree is reached, a corresponding interrupt is asserted. The tree score can be then read by the MPU from a status FIFO in the set of FIFOs 710.

The MPU 514 can schedule several trees to be processed at once, up to the size of the command FIFO, and to read several results at once, up to the size of the status FIFO, thus minimizing the required frequency of communication between the MPU and the back-end accelerator 512A.

In order to keep correspondence between tree pointers written in the command FIFO and the tree scores read back from the status FIFO, each tree pointer should be accompanied by a unique tree ID. The tree parsing unit 706 attaches this ID to the resulting score so that the MPU is able to establish such correspondence while reading the tree scores from the status FIFO.

The execution pipeline 708 includes first and second multiply-accumulate (MAC) units 714-1 and 714-2, also denoted as MAC 1 and MAC 2, respectively, and a threshold comparison unit 716. The execution pipeline performs rectangle sum calculation in MAC 1, feature calculation including generation of a weighted sum of the rectangle sums in MAC 2, and feature comparison with a threshold in the threshold comparison unit 716.

The process of traversing through a given decision tree is not pipelined in the present embodiment since it is unknown which node will execute next until the very last operation for the current tree node is complete. However, in order to reach a sufficiently high level of performance (e.g., calculation of one rectangle sum in four clock cycles), the back-end accelerator 712A employs multithreading by working on more than one tree in parallel. More particularly, when a current tree execution process reaches a waiting point and is suspended, the tree parsing unit 706 reads the next available entry from the command FIFO and starts calculations for the next tree until the next node data for the suspended process arrives.

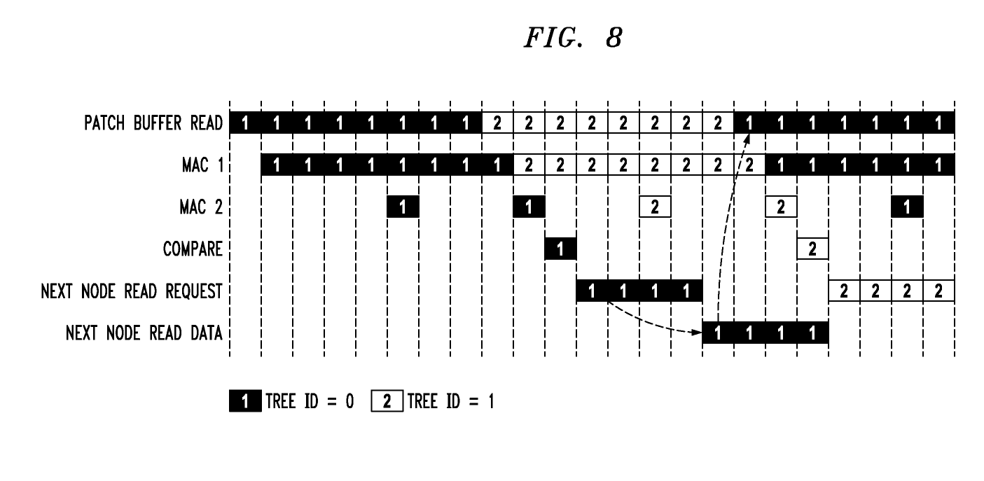

This exemplary multithreading implemented in the back-end accelerator 512A is illustrated in FIG. 8, which shows the relative timing of operations of two different threads, referred to as Thread 1 and Thread 2. These two threads operate on respective trees having tree identifiers denoted as Tree ID 0 and Tree ID 1. Each of the threads is processed over time using operations that in this example include Patch Buffer Read, MAC 1, MAC 2, Compare, Next Node Read Request and Next Node Read Data. It can be seen that certain operations for Thread 2 are commenced prior to completion of the MAC 1, MAC 2 and Compare operations for a current node of Thread 1. After the next node is determined for Thread 1 and the corresponding requested data is obtained by the Patch Buffer Read operation, the MAC 1, MAC 2 and Compare operations for the next node are performed for Thread 1. The particular ordering of operations shown in the figure is presented by way of example only, and other types of multithreading may be used in other embodiments.

It was noted above that with more than one tree being executed in parallel, it may not be possible to determine which tree will be completed first. As indicated previously, in order to maintain unambiguous correspondence between commands and tree scores, each tree is assigned a unique ID, which is reported to the MPU 514 along with the tree score. The number of such IDs is illustratively equal to the number of entries in the command and status FIFOs 710 (e.g., 16 entries).

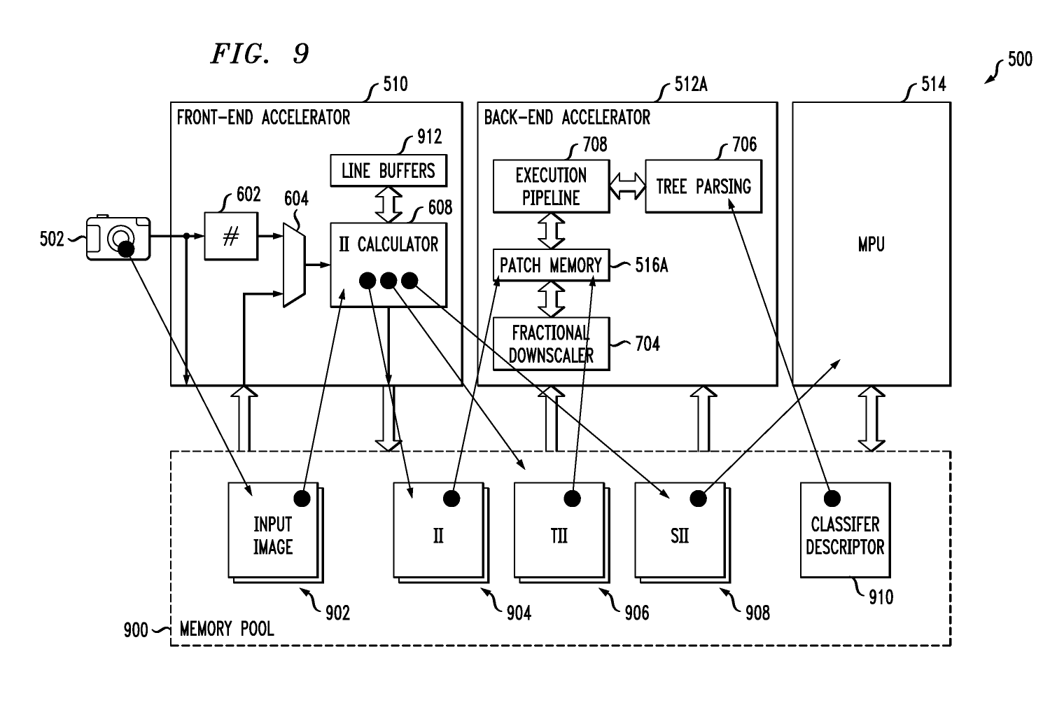

FIG. 9 illustrates an exemplary dataflow in the IC 500 of FIG. 5. In this embodiment, a memory pool 900 is assumed to comprise at least a portion of on-chip SRAM 516 and may also comprise at least a portion of external DRAM 504. The memory pool 900 stores input images 902 obtained from the external imaging sensor 502. It also stores integral images 904, tilted integral images 906 and squared integral images 908, computed by the integral image calculator 608 of the front-end accelerator 510, and a classifier descriptor 910. The integral image calculator 608 utilizes line buffers 912 in computing the integral images.

The front-end accelerator 510 calculates the integral images over an entire input image or an ROI of an input image in either an on-the-fly manner (e.g., as the input image is being captured) or in a post-processing mode (e.g., the input image is captured and stored in the memory pool first and then the integral images are calculated).

The back-end accelerator 512A reads patches of the integral images from the memory pool, down-scales them to the required resolution in fractional downscaler 704 and calculates the tree scores for the resized patches, using tree parsing unit 706 and execution pipeline 708 as previously described. In this embodiment, an SRAM instance 516A is assumed to serve as a patch memory for the back-end accelerator 512A.

As illustrated in the figure, the classifier descriptor 910 is utilized by the tree parsing unit 706, and the squared integral images are utilized by the MPU 514.

The hardware-accelerated embodiment of FIG. 5 is capable of processing image patches at different offsets and scales. However, its performance in some applications of this type can be limited, possibly as a result of factors such as non-consecutive memory access patterns in the back-end accelerator when resizing integral image patches at different scales, memory rereads when consecutively accessing overlapping patches, and processor workload associated with patch normalization operations.

Embodiments of the present invention to be described below in conjunction with FIGS. 10 through 14 provide improved performance in the presence of one or more of the above factors. For example, these embodiments are illustratively configured to partition a scaling process into two stages, namely, coarse image or integral image resolution pyramid generation in the front-end accelerator 510 and fine downscaling in the back-end accelerator 512. These embodiments also provide improved integral image buffering in the back-end accelerator 512, and re-assign patch normalization operations from software to hardware.

Referring initially to FIG. 10, an image processor 1000 in an illustrative embodiment is configured generally as described in conjunction with the FIG. 9 embodiment but includes an integer downscaler 1002 in the front-end accelerator 510 and a patch normalization unit 1004 in the back-end accelerator 512A.

The integer downscaler 1002 generates downscaled versions of the integral images 904, tilted integral images 906 and squared integral images 908 computed by the integral image calculator 608. The downscaled images as stored in the memory pool 900 include factor-of-two (:2) downscaled integral images and factor-of-four (:4) downscaled integral images. These downscaled images are more particularly denoted as 904₂ and 904₄ for the respective factor-of-two and factor-of-four downscaled integral images, 906₂ and 906₄ for the respective factor-of-two and factor-of-four downscaled tilted integral images, and 908₂ and 908₄ for the respective factor-of-two and factor-of-four downscaled squared integral images. Although only factor-of-two and factor-of-four downscaled images are shown in memory pool 900 in the figure, additional downscaled images may be generated by the integer downscaler 1002, such as factor-of-eight (:8) downscaled images.

Accordingly, in the FIG. 10 embodiment, the integral downscaler 1002 in the front-end accelerator 510 generates multiple downscaled versions of each of the integral images, tilted integral images and squared integral images generated by the integral image calculator 608. A given integral image and its associated multiple downscaled versions are collectively referred to herein as an “image resolution pyramid” of integral images. The image resolution pyramid of integral images is illustratively computed using integer downscaling by factors of two, and thus with single octave steps between consecutive levels of the pyramid. The generation of an image resolution pyramid of integral images in the FIG. 10 embodiment can be implemented, for example, using simple decimation without an anti-aliasing filter, due to the anti-aliasing properties of integral images.

The back-end accelerator 512A in this embodiment further comprises first and second line memories 1010-1 and 1010-2. The first line memory 1010-1 is utilized to process integral images 904 and tilted integral images 906 or associated downscaled versions thereof, and the second line memory 1010-2 is utilized to process squared integral images 908 or associated downscaled versions thereof.

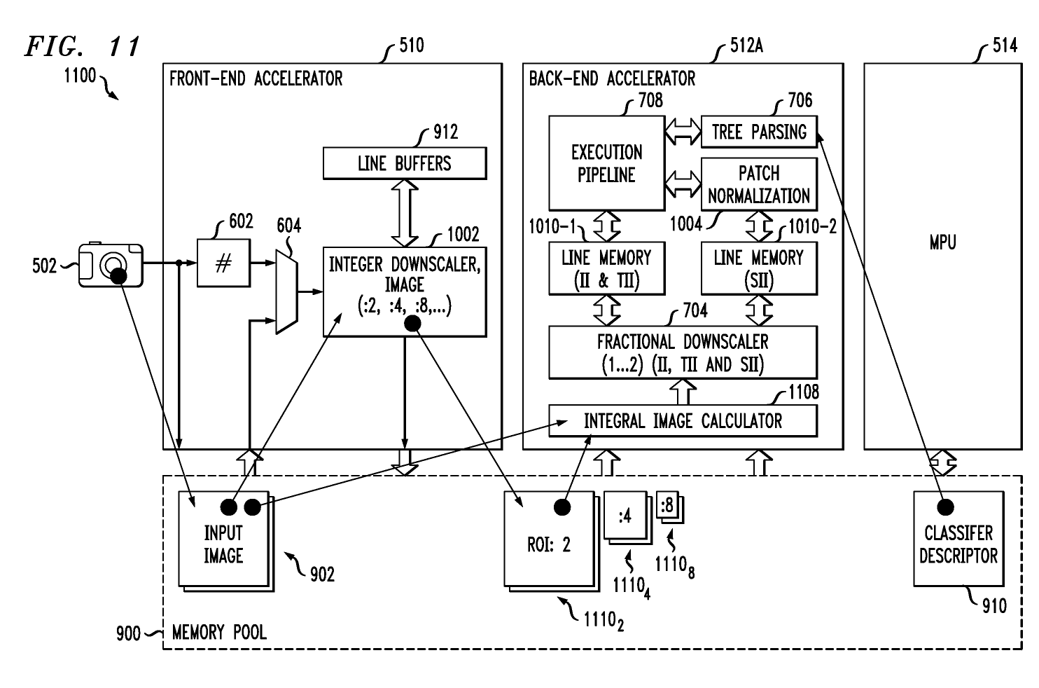

With reference now to FIG. 11, an image processor 1100 in an illustrative embodiment is configured generally as described in conjunction with the FIG. 10 embodiment but includes an integral image calculator 1108 in the back-end accelerator 512A instead of the integral image calculator 608 in the front-end accelerator 510. The integer downscaler 1002 in this embodiment operates on input images 902 to generate downscaled versions of ROIs in respective ones of those images, including factor-of-two downscaled ROIs 1110₂, factor-of-four downscaled ROIs 1110₄, and factor-of-eight downscaled ROIs 1110₈. A given input image and its associated downscaled versions is another example of an “image resolution pyramid” as that term is broadly used herein. The integral image calculator 1108 utilizes the input images 902 as well as the associated downscaled ROIs 1110 to compute integral images, tilted integral images and squared integral images for further processing by the tree parsing unit 706 and the execution pipeline 708 of the back-end accelerator 512A.

The generation of an image resolution pyramid using integer downscaler 1002 in the FIG. 11 embodiment is illustratively implemented using a “box” anti-aliasing filter, although numerous other downscaling techniques can be used. For example, downscaling with a box anti-aliasing filter can be carried out in accordance with the following equation:

$${I}_{out} ( v , h ) = {\sum }_{i = 0}^{{K}_{h} - 1} {\sum }_{j = 0}^{{K}_{v} - 1} I ( {K}_{v} v + j , {K}_{h} h + i ) .$$

As mentioned previously, such an anti-aliasing filter is not utilized in an embodiment such as that of FIG. 10 in which the integer downscaler 1002 generates an image resolution pyramid of integral images.

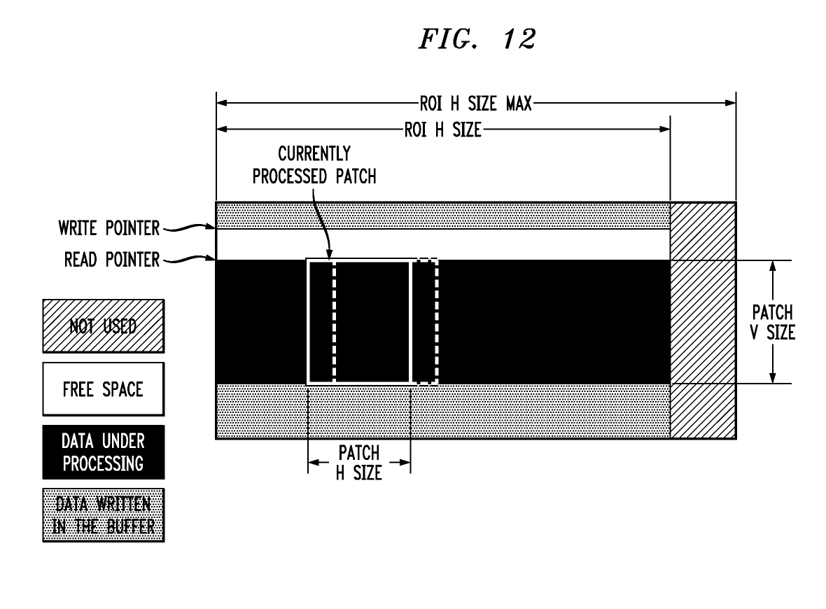

In both the FIG. 10 and FIG. 11 embodiments, buffering of the integral images in each of the line memories 1010-1 and 1010-2 is organized in a circular manner as shown in FIG. 12. A given such line memory 1010, also referred to herein as a buffer, stores a designated number of rows of an integral image so as to fully cover a horizontal stripe of image patches comprising image data under processing and includes sufficient free space for prefetching a designated number of additional rows in advance. The figure shows the horizontal and vertical size of a currently processed image patch, which is part of the above-noted horizontal stripe of image patches comprising the image data under processing. The horizontal stripe of image patches is part of a current ROI having the horizontal size as indicated. The line memory is configured to accommodate a designated maximum ROI horizontal size, with the difference between the maximum ROI horizontal size and the current ROI horizontal size representing unused space. The figure also illustrates data written to the line memory, and shows a write pointer and a read pointer on opposite sides of the free space region.

The line memories 1010 can be operated in multiple modes, including by way of example an automatic mode and a software-controlled mode. In the automatic mode, the back-end accelerator 512A steps through all vertical and horizontal offsets within a selected scale automatically using specified vertical and horizontal patch steps. In the software-controlled mode, software running on MPU 514 selects a current patch offset within the horizontal stripe currently being processed and moves the read pointer when processing of the horizontal stripe has been completed. The software in the software-controlled mode can also include functionality for aborting a current fetch in progress, clearing the line memory and re-starting the processing using a new ROI and scale.

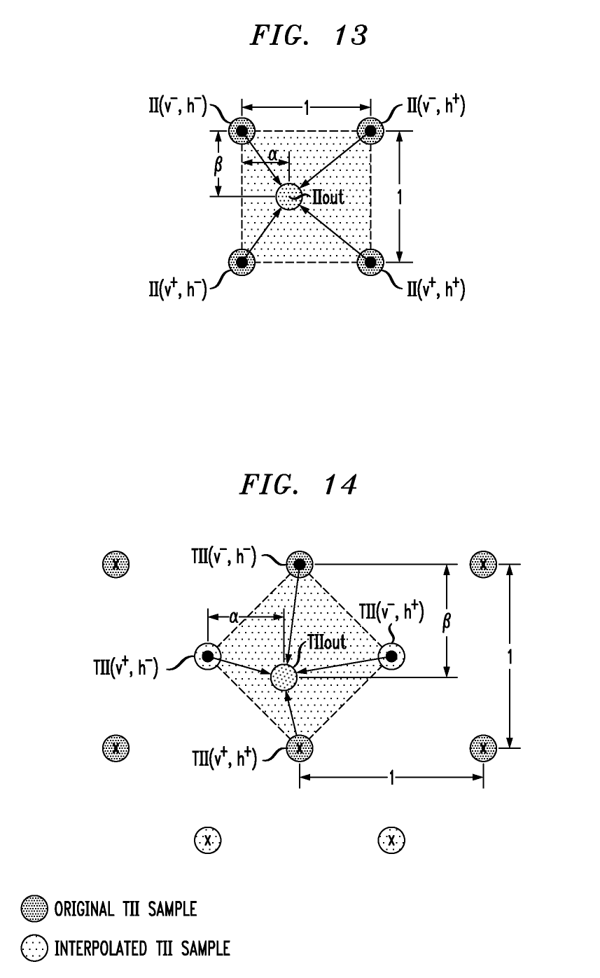

The fractional downscaling of integral images in fractional downscaler 704 of the embodiments of FIGS. 10 and 11 can be carried out using a variety of different techniques, examples of which are illustrated in FIGS. 13 and 14.

With reference to FIG. 13, exemplary fractional downscaling for integral images and squared integral images is illustrated. The diagram more specifically shows a downscaled integral image pixel generated from a group of four integral image pixels, although similar processing is assumed for squared integral images. In this example, fractional downscaling of integral images and squared integral images is implemented utilizing bi-linear interpolation in accordance with the following equations:

$${II}_{out} ( v , h ) = [ \begin{matrix}αβ & ( 1 - α ) β \\ α ( 1 - β ) & ( 1 - α ) ( 1 - β )\end{matrix} ] {\text{:} [ \begin{matrix}II ( {v}^{-} , {h}^{-} ) & II ( {v}^{-} , {h}^{+} ) \\ II ( {v}^{+} , {h}^{-} ) & II ( {v}^{+} , {h}^{+} )\end{matrix} ]}^{T}$$

$${SII}_{out} ( v , h ) = [ \begin{matrix}αβ & ( 1 - α ) β \\ α ( 1 - β ) & ( 1 - α ) ( 1 - β )\end{matrix} ] {\text{:} [ \begin{matrix}SII ( {v}^{-} , {h}^{-} ) & SII ( {v}^{-} , {h}^{+} ) \\ SII ( {v}^{+} , {h}^{-} ) & SII ( {v}^{+} , {h}^{+} )\end{matrix} ]}^{T}$$

where α and β are defined as shown in the figure, the matrix operator T denotes transpose and the matrix operator “:” denotes Frobenius inner product.

With reference to FIG. 14, exemplary fractional downscaling for tilted integral images is illustrated. The diagram more specifically shows a downscaled integral image pixel generated from a group of original and interpolated tilted integral image pixels. In this example, fractional downscaling of tilted integral images is implemented utilizing directional bi-linear interpolation on an interpolated sampling grid in accordance with the following equations:

$${α}_{R} = \frac{2 ( β + α ) - 1}{2}$$

$${β}_{R} = \frac{2 ( β - α ) + 1}{2}$$

$${TII}_{out} ( v , h ) = [ \begin{matrix}{α}_{R} {β}_{R} & ( 1 - {α}_{R} ) {β}_{R} \\ {α}_{R} ( 1 - {β}_{R} ) & ( 1 - {α}_{R} ) ( 1 - {β}_{R} )\end{matrix} ] {\text{:} [ \begin{matrix}TII ( {v}^{-} , {h}^{-} ) & TII ( {v}^{-} , {h}^{+} ) \\ TII ( {v}^{+} , {h}^{-} ) & TII ( {v}^{+} , {h}^{+} )\end{matrix} ]}^{T}$$

where once again α and β are defined as shown in the figure, the matrix operator T denotes transpose and the matrix operator “:” denotes Frobenius inner product.

The particular fractional downscaling techniques illustrated in FIGS. 13 and 14 are exemplary only, and alternative techniques may be used.

In the embodiments of FIGS. 10 and 11, the patch normalization unit 1004 of the back-end accelerator is configured to achieve classifier invariance to patch contrast, and illustratively performs both Haar-like feature normalization and node threshold normalization utilizing the following equations:

$${R}_{norm} = \frac{R}{{Size}_{h} \times {Size}_{v}}$$

$$StdDev = \sqrt{\frac{{\sum }_{v = 0}^{{Size}_{h} - 1} {\sum }_{h = 0}^{{Size}_{v} - 1} {I}^{2} ( v , h )}{{Size}_{h} \times {Size}_{v}} - {( \frac{{\sum }_{v = 0}^{{Size}_{h} - 1} {\sum }_{h = 0}^{{Size}_{v} - 1} I ( v , h )}{{Size}_{h} \times {Size}_{v}} )}^{2}}$$

$${NodeThresh}_{norm} = NodeThresh \cdot StdDev$$

In these equations, Rₙₒᵣₘ denotes the normalized rectangular sum generated from the previously-described rectangular sum R, Sizeₕ and Sizeᵥ denote the respective horizontal and vertical sizes of the image patch, StdDev denotes the standard deviation of the pixels of the image patch, and NodeThresh denotes the node threshold applied in the threshold comparison unit 716. The patch normalization unit 1004 provides the normalized rectangular sums and node thresholds to the execution pipeline 708.

It is important to note that the embodiments described above are exemplary only, and that numerous alternative arrangements are possible.

For example, one or more of the nodes in at least one tree of at least one stage of a given classifier may utilize non-Haar-like features. In such embodiments, the execution pipeline can be adapted in a straightforward manner to calculate non-Haar-like features such as Gabor wavelet, Histogram-of-Gradients (HoG) or other types of features used in computer vision applications. Accordingly, the particular types and arrangements of features that are associated with respective tree nodes may be varied in other embodiments.

As another example, an image processor in another embodiment may be configured to pass a single pointer to a list of tree root pointers and an accumulated score threshold so the accelerator can autonomously process successive trees in a given stage or class without MPU intervention.

As yet another example, an image processor in another embodiment may be configured to provide tree outputs as a class number in addition to a score, with majority voting on the classes, possibly for use in random forest classifier embodiments.

An image processor such as that illustrated in FIG. 5 can be implemented in an image processing system. For example, such an image processing system may comprise an image processor of the type shown in FIG. 5 configured for communication over a network with a plurality of processing devices.

Moreover, it is to be appreciated that a given image processor may itself comprise multiple distinct processing devices. The term “image processor” as used herein is intended to be broadly construed so as to encompass these and other arrangements.

The image data received by an image processor as disclosed herein may comprise, for example, raw image data received from a depth sensor or other type of imaging sensor. A wide variety of other types of images or combinations of multiple images may be used in other embodiments. It should therefore be understood that the term “image” as used herein is intended to be broadly construed.

The image processor may interface with a variety of different image sources and image destinations. For example, the image processor may receive input images from one or more image sources and provide processed images to one or more image destinations. At least a subset of such image sources and image destinations may be implemented as least in part utilizing one or more processing devices.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Other types and arrangements of images may be received, processed and generated in other embodiments, including combinations of 2D and 3D images.

Another example of an image source is a storage device or server that provides images to the image processor for processing.

A given image destination may comprise, for example, one or more display screens of a human-machine interface of a computer or mobile phone, or at least one storage device or server that receives processed images from the image processor.

It should also be noted that the image processor may be at least partially combined with at least a subset of the one or more image sources and the one or more image destinations on a common processing device. Thus, for example, a given image source and the image processor may be collectively implemented on the same processing device. Similarly, a given image destination and the image processor may be collectively implemented on the same processing device.

The particular number and arrangement of processing units and other image processor components in the illustrative embodiments of FIGS. 5-7, 9, 10 and 11 can be varied in other embodiments. For example, in other embodiments two or more of the processing units may be combined into a lesser number of processing units. An otherwise conventional image processing integrated circuit or other type of image processing circuitry suitably modified to perform processing operations as disclosed herein may be used to implement at least a portion of one or more of the processing units or other components of the image processor. One possible example of image processing circuitry that may be used in one or more embodiments of the invention is an otherwise conventional graphics processor suitably reconfigured to perform functionality associated with one or more of the processing units or other image processing components described herein.

The processing devices referred to above may comprise, for example, computers, mobile phones, servers or storage devices, in any combination. One or more such devices also may include, for example, display screens or other user interfaces that are utilized to present images generated by the image processor. The processing devices may therefore comprise a wide variety of different destination devices that receive processed image streams or other types of outputs from the image processor, possibly over a network, including by way of example at least one server or storage device that receives one or more processed image streams or associated information from the image processor.

As indicated previously, an image processor may be at least partially combined with one or more image sources or image destinations on a common processing device. By way of example, a computer or mobile phone may be configured to incorporate the image processor and an image source such as a camera. Image sources utilized to provide input images in an image processing system may therefore comprise cameras or other imagers associated with a computer, mobile phone or other processing device.

An image processor as disclosed herein is assumed to be implemented using at least one processing device and comprises a processor coupled to a memory. The processor executes software code stored in the memory in order to control the performance of processing operations and other functionality. The image processor may also comprise a network interface that supports communication over one or more networks.

The processor may comprise, for example, a microprocessor such as the MPU noted above, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory stores software code for execution by the processor in implementing portions of the functionality of the image processor. A given such memory that stores software code for execution by a corresponding processor is an example of what is more generally referred to herein as a computer-readable storage medium having computer program code embodied therein, and may comprise, for example, electronic memory such as SRAM, DRAM or other types of random access memory, read-only memory (ROM), magnetic memory, optical memory, or other types of storage devices in any combination.

Articles of manufacture comprising such computer-readable storage media are considered embodiments of the invention. The term “article of manufacture” as used herein should be understood to exclude transitory, propagating signals.

It should also be understood that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configurations of image processing systems described herein are exemplary only, and a given such system in other embodiments may include other elements in addition to or in place of those specifically shown, including one or more elements of a type commonly found in a conventional implementation of such a system.

For example, in some embodiments, an image processing system is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize at least one of object recognition and tracking.

It is also to be appreciated that the particular process steps used in the embodiments described above are exemplary only, and other embodiments can utilize different types and arrangements of processing operations. For example, the particular manner in which image data is processed through the trees and stages of a given classifier can be varied in other embodiments.

It should again be emphasized that the embodiments of the invention as described herein are intended to be illustrative only. For example, other embodiments of the invention can be implemented utilizing a wide variety of different types and arrangements of image processing circuitry, processing units and processing operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. An apparatus comprising:
an image processor comprising first and second hardware accelerators;
the image processor being configured to implement a classifier utilizing the first and second hardware accelerators;
wherein at least one of the first and second hardware accelerators is configured to generate an integral image based on a given input image; and
wherein the second hardware accelerator is configured to process image patches of the integral image through one or more of a plurality of decision trees of the classifier implemented by the image processor.

2. The apparatus of claim 1 wherein the first and second hardware accelerators comprise respective front-end and back-end accelerators of the image processor.

3. The apparatus of claim 1 wherein the classifier comprises a cascaded classifier having a plurality of stages with each such stage implementing a plurality of decision trees.

4. The apparatus of claim 1 wherein the first hardware accelerator comprises an image signal processing unit configured to perform one or more image signal processing operations on the input image prior to or in conjunction with generation of the integral image.

5. The apparatus of claim 1 wherein the first hardware accelerator comprises an integer downscaler configured to generate one or more downscaled versions of at least one of the input image and the integral image.

6. The apparatus of claim 1 wherein the first hardware accelerator comprises an integral image calculator configured to generate the integral image based on the given input image.

7. The apparatus of claim 1 wherein the second hardware accelerator comprises:
a patch fetch unit configured to retrieve from memory the image patches of the integral image;
a tree parsing unit controlling movement through multiple nodes of at least one of the plurality of decision trees for each of the retrieved image patches; and
an execution pipeline implementing operations associated with feature calculation and threshold comparison for each of the retrieved image patches for the multiple nodes of at least one of the plurality of decision trees.

8. The apparatus of claim 7 wherein the execution pipeline comprises:
a first multiply-accumulate unit configured to perform a rectangle sum calculation;
a second multiply-accumulate unit configured to calculate a feature including a weighted sum of rectangle sums calculated by the first multiply-accumulate unit; and
a threshold comparison unit configured to compare the feature calculated by the second multiply-accumulate unit with a specified threshold associated with at least one of the multiple nodes.

9. The apparatus of claim 7 wherein the second hardware accelerator further comprises a fractional downscaler configured to implement fractional downscaling of the retrieved image patches utilizing bi-linear interpolation.

10. The apparatus of claim 7 wherein the second hardware accelerator further comprises a patch normalization unit configured to perform at least one of feature normalization and threshold normalization for the retrieved image patches.

11. The apparatus of claim 1 wherein the second hardware accelerator comprises an integral image calculator configured to generate the integral image based on the given input image.

12. The apparatus of claim 1 wherein the image processor further comprises a microprocessor unit coupled to the first and second hardware accelerators.

13. The apparatus of claim 1 wherein the image processor is adapted for interfacing with an external imaging sensor.

14. The apparatus of claim 1 wherein the image processor comprises a plurality of parallel instances of the second hardware accelerator.

15. The apparatus of claim 1 wherein the image processor is implemented in the form of a system-on-a-chip.

16. An integrated circuit comprising the apparatus of claim 1.

17. An image processing system comprising the apparatus of claim 1.

18. A method comprising:
in at least one of first and second hardware accelerators of an image processor, generating an integral image based on a given received image; and
in the second hardware accelerator of the image processor, processing image patches of the integral image through one or more of a plurality of decision trees of a classifier implemented by the image processor.

19. The method of claim 18 further comprising the step of performing at least one of an object recognition operation and an object tracking operation based on outputs provided by the second hardware accelerator.

20. An article of manufacture comprising a computer-readable storage medium having computer program code embodied therein, wherein the computer program code when executed in the image processor causes the image processor to perform the method of claim 18.
